(19) United States
(12) Patent Application Publication
(10) Pub. No.: US 2011/0096230 A1
(43) Pub. Date: Apr. 28, 2011

(54) TERMINAL DEVICE AND METHOD FOR PROCESSING DATA

(76) Inventors: Daisaku Komiya, Tokyo (JP); Kenichi Fujita, Osaka (JP); Hidenori Ishii, Tokyo (JP)

(21) Appl. No.: 13/001,775

(22) PCT Filed: Jun. 29, 2009
(86) PCT No.: PCT/JP2009/002994

§ 371 Date: Dec. 28, 2010

(30) Foreign Application Priority Data
Jun. 30, 2008 (JP) 2008-171227

(51) Int. Cl. H04N 7/01

(52) U.S. Cl. 348/441; 348/E07.003

(57) ABSTRACT

Provided is a terminal device that can make an external display device show an enlarged website screen for every object to improve user convenience. A terminal device (103) is a mobile terminal device that can be connected with an external display device (104). The terminal device is provided with an information acquisition unit (203) that acquires information which is used for displaying a website screen and is comprised of an object including a parameter for specifying a screen size of the website screen, a parameter change unit (207) that changes the parameter so as to increase the screen size, a data processing unit (211) that carries out decoding process of the object, thereby generating screen information of the screen size specified by the changed parameter, and a communication unit (214) that outputs the generated screen information to the external display device (104).

### TECHNICAL FIELD

The present invention relates to a terminal apparatus and data processing method, and more particularly to a terminal apparatus and data processing method whereby connection is made to an external display apparatus and a screen is displayed on the external display apparatus.

### BACKGROUND ART

In recent years, the processing performance of mobile phones has improved, and models have been released that incorporate a Web browser enabling Web pages created for personal computer use to be viewed. Furthermore, mobile information terminals have also appeared that are capable of accessing the Internet via a wireless LAN or public wireless network. Terminal apparatuses such as these mobile phones and mobile information terminals are designed to be carried by a user outside the home, and can be used anywhere—in a train, a park, a street cafe, and so forth—thus offering great user convenience.

However, the emphasis on portability of a terminal apparatus means that its size is limited, and the display of a terminal apparatus is generally around 3 inches in line with the size of the terminal. Therefore, when a Web screen containing a large amount of information is viewed on a terminal apparatus, the text is extremely small, and may not be legible. Measures used to solve this problem include switching to a larger font for display on a terminal apparatus, or using an enlargement mode in which a predetermined part of the screen is displayed in enlarged form. In this case, however, only part of the screen can be seen at one time, and scrolling is repeated again and again, often making it all the more difficult to grasp the contents.

As a way of overcoming the inconvenience caused by the small display of a terminal apparatus, a technology has already been commercialized whereby, when a user is at home or in a hotel, display can be performed on a TV monitor, thus eliminating this inconvenience. This technology is called a TV output function or AV output function. With this technology, a terminal apparatus is connected to a television by means of a video cable, and a terminal apparatus display screen is displayed on the display of the television by using the terminal apparatus display screen output as external video input of the television. As a result, an image displayed on the display of the terminal apparatus is displayed on the display of the television. However, this only provides an enlarged display of a screen image displayed on the display of the terminal apparatus, and resolution is not increased in line with the resolution of the television display. As a result, an image displayed on the television display is fuzzy.

Patent Literature 1 discloses a technology whose object is to solve this problem by displaying an image of higher resolution than the screen resolution of a terminal apparatus on a large-screen external display apparatus. Normally, when a Web screen created for personal computer use is displayed on a terminal apparatus using a browser, only part of the Web screen can be displayed. In contrast, when an external display apparatus is switched to and a Web screen is displayed on that external display apparatus, it is possible to display the Web screen as intended by the Web screen creator (using the layout used when the Web screen is viewed on a personal computer). Therefore, according to the technology disclosed in Patent Literature 1, an image of higher resolution than the screen resolution of a terminal apparatus can be displayed on a large-screen external display apparatus.

### CITATION LIST

### Patent Literature

PTL 1
Japanese Patent Application Laid-Open No. 2007-95080

### SUMMARY OF INVENTION

### Technical Problem

However, the technology described in Patent Literature 1 only displays an image of increased resolution on an external display apparatus. Therefore, a problem with such technology is that a user cannot be provided with an advantage greater than that of enabling a clear image to be displayed on a large screen.

It is an object of the present invention to provide a terminal apparatus and data processing method that make it possible for enlarged display of a Web screen to be performed on an external display apparatus on an object-by-object basis, and enable user convenience to be greatly improved.

### Solution to Problem

A terminal apparatus of the present invention is a portable terminal capable of connection to an external display apparatus, and has: an acquisition section that acquires Web screen display information composed of an object including a parameter specifying a screen size of a Web screen; a changing section that changes the parameter so that the screen size is increased; a data processing section that generates screen information of the screen size specified by the changed parameter by performing decoding processing on the object; and an output section that outputs the generated screen information to the external display apparatus.

A terminal apparatus of the present invention is a portable terminal capable of connection to an external display apparatus, and has: an acquisition section that acquires an object including a parameter specifying a screen size of a network application screen; a changing section that changes the parameter so that the screen size is increased; a data processing section that generates screen information of the screen size specified by the changed parameter by performing decoding processing on the object; and an output section that outputs the generated screen information to the external display apparatus.

A data processing method of the present invention is a data processing method that is used by a terminal apparatus capable of connection to an external display apparatus, and has: a step of acquiring Web screen display information composed of an object including a parameter specifying a screen size of a Web screen; a step of determining whether or not screen information is to be output to the external display apparatus; a step of changing the parameter so that the screen size is increased when it is determined that the screen information is to be output to the external display apparatus; a step of generating screen information of the screen size specified by a changed parameter by decoding the object; and a step of outputting generated screen information to the external display apparatus via the output section.

A data processing method of the present invention is a data processing method that is used by a terminal apparatus capable of connection to an external display apparatus, and has: a step of acquiring an object including a parameter specifying a screen size of a network application screen; a step of determining whether or not screen information is to be output to the external display apparatus; a step of changing the parameter so that the screen size is increased when it is determined that the screen information is to be output to the external display apparatus; a step of generating screen information of the screen size specified by the changed parameter by decoding the object; and a step of outputting the generated screen information to the external display apparatus via the output section.

### ADVANTAGEOUS EFFECTS OF INVENTION

The present invention makes it possible for enlarged display of a Web screen to be performed on an external display apparatus on an object-by-object basis, and enables user convenience to be greatly improved.

### BRIEF DESCRIPTION OF DRAWINGS

FIG. 1 is a drawing showing a communication system according to an embodiment of the present invention;

FIG. 2 is a block diagram showing the configuration of a terminal apparatus according to an embodiment of the present invention;

FIG. 3 is a flowchart showing terminal apparatus operation when a terminal apparatus according to an embodiment of the present invention accesses a video sharing service;

FIG. 4 is a drawing showing an extract of Web page data of a page including video according to an embodiment of the present invention;

FIG. 5 is a drawing showing data after a parameter changing section has changed a parameter in order to perform full-screen display of a Web page including video on a display section of an external display apparatus according to an embodiment of the present invention;

FIG. 6 comprises drawings showing screens displayed on a display section and an external display apparatus according to an embodiment of the present invention;

FIG. 7 is a flowchart showing terminal apparatus operation when a link destination screen of link information in a Web screen is displayed according to an embodiment of the present invention;

FIG. 8 is a drawing showing an example of the configuration of a terminal apparatus according to an embodiment of the present invention;

FIG. 9 is a drawing showing an example of the configuration of a terminal apparatus according to an embodiment of the present invention; and

FIG. 10 is a flowchart showing terminal apparatus operation when an input section is manipulated according to an embodiment of the present invention.

### DESCRIPTION OF EMBODIMENTS

Now, an embodiment of the present invention will be described in detail with reference to the accompanying drawings.

### Embodiment

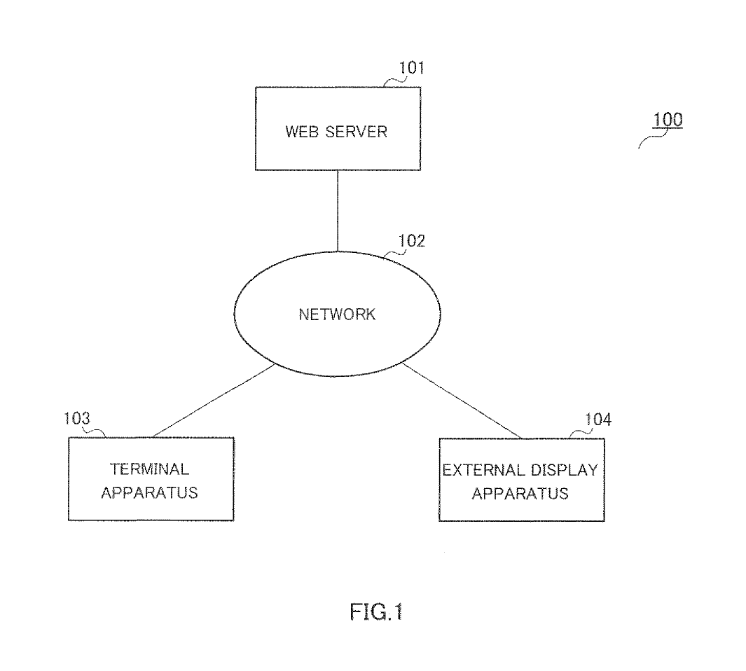

FIG. 1 is a drawing showing communication system 100 according to an embodiment of the present invention.

Communication system 100 is mainly composed of Web server 101, network 102, terminal apparatus 103, and external display apparatus 104.

Terminal apparatus 103 accesses Web server 101 via network 102 and acquires Web screen display information, and generates a Web screen based on the acquired Web screen display information.

External display apparatus 104 receives screen information of part or all of the Web screen generated by terminal apparatus 103 via network 102, and displays the received screen information.

In this configuration, whether network 102 is wired or wireless is not a problem, and the network is generally implemented in such a way that a certain section is wired and a certain section is wireless. With regard to the physical positional relationship between terminal apparatus 103 and external display apparatus 104, an extremely short distance is assumed, such as both being in the same room, for example. Network 102 connecting terminal apparatus 103 and external display apparatus 104 need not necessarily be a PAN (Personal Area Network), and may be a wireless LAN or the like.

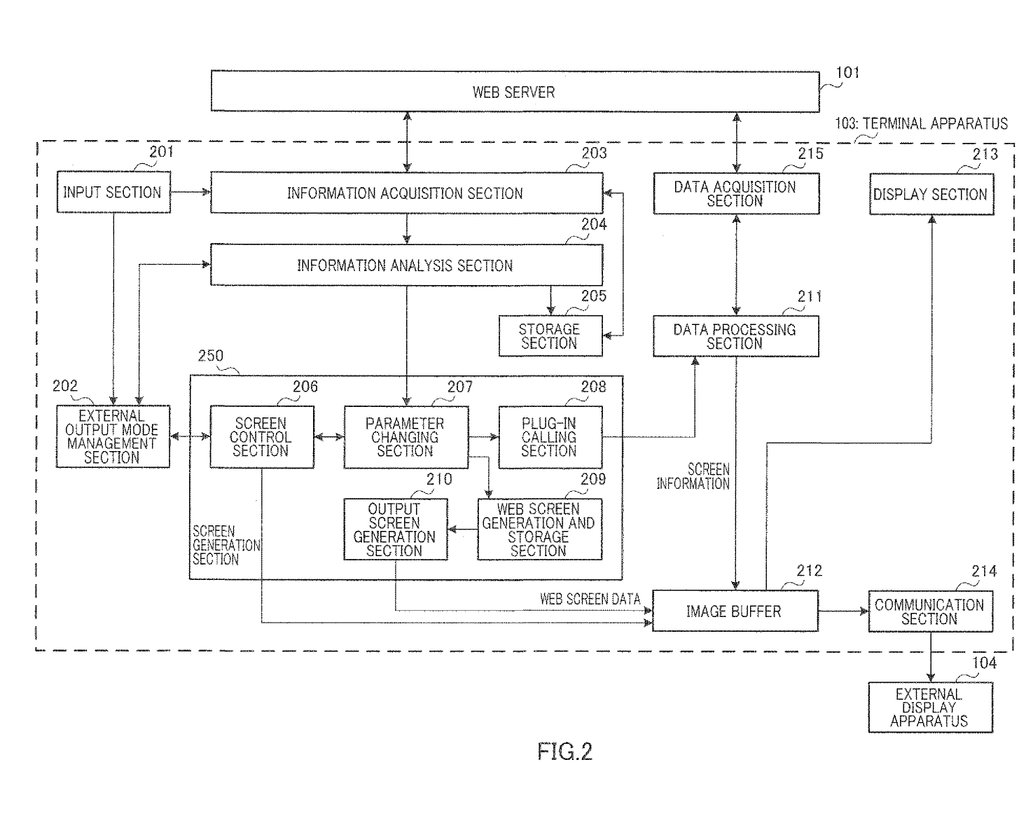

The configuration of terminal apparatus 103 will now be described using FIG. 2. FIG. 2 is a block diagram showing the configuration of terminal apparatus 103. Terminal apparatus 103 is mainly composed of input section 201, external output mode management section 202, information acquisition section 203, information analysis section 204, storage section 205, data processing section 211, image buffer 212, display section 213, communication section 214, data acquisition section 215, and screen generation section 250.

Screen generation section 250 includes screen control section 206, parameter changing section 207, plug-in calling section 208, Web screen generation and storage section 209, and output screen generation section 210.

Input section 201 is an input device for receiving input of information from a user. Specifically, on receiving a directive from a user to output data from terminal apparatus 103 to external display apparatus 104, input section 201 outputs the received directive to external output mode management section 202 as input information. Also, on receiving a directive from a user to acquire Web screen display information from Web server 101, input section 201 outputs the received directive to information acquisition section 203 as input information. Moreover, on receiving a directive from a user to perform enlarged display of only part of a Web screen or to perform enlarged display of an entire Web screen, input section 201 outputs the received directive to external output mode management section 202 as input information. Furthermore, on receiving a directive from a user to select link destination information, input section 201 outputs the received directive to information acquisition section 203 as input information.

When input information directing data output to external display apparatus 104 is input from input section 201, external output mode management section 202 sets external output mode. External output mode is a mode in which data is output to external display apparatus 104. Also, external output mode management section 202 sets normal output mode until input information directing data output to external display apparatus 104 is input from input section 201. Normal output mode is a mode in which data is not output to external display apparatus 104. Then external output mode management section 202 manages data output according to the set mode. When input information directing Web screen enlarged display is input from input section 201, external output mode management section 202 holds that input information.

When input information directing acquisition of Web screen display information is input from input section 201, information acquisition section 203 functioning as a Web screen display information acquisition section acquires Web screen display information from Web server 101. Also, when input information directing selection of link destination information is input from input section 201, information acquisition section 203 selects a link destination URL from Web screen display information stored in storage section 205. Then information acquisition section 203 acquires Web screen display information of the selected link destination from Web server 101. Also, information acquisition section 203 outputs the acquired Web screen display information to information analysis section 204.

Information analysis section 204 parses Web screen display information input from information acquisition section 203, and generates parsed information. Information analysis section 204 outputs the generated parsed information to parameter changing section 207. Also, information analysis section 204 issues an inquiry to external output mode management section 202, and stores parsed information in a predetermined storage area of storage section 205 according to whether the mode is external output mode or normal output mode. Here, Web screen display information comprises an object including a parameter indicating the screen size of a Web screen, and is HTML or XHTML, for example. Parsing means processing to extract on an object-by-object basis a plurality of objects composing acquired Web screen display information, and parsed information is information for each object extracted from Web screen display information.

Storage section 205 stores Web screen display information input from information analysis section 204.

On receiving notification that parsed information has been received from parameter changing section 207, screen control section 206 issues an inquiry as to the set mode to external output mode management section 202. If the result of the inquiry is that external output mode has been set, screen control section 206 directs parameter changing section 207 to change a parameter indicating the screen size of the Web screen in order to perform display on external display apparatus 104. Then screen control section 206 performs control so that data written to image buffer 212 is output to communication section 214. On the other hand, if the result of the inquiry as to the set mode is that normal output mode has been set, screen control section 206 does not direct parameter changing section 207 to make a parameter change, and performs control so that data written to image buffer 212 is output to display section 213.

Also, screen control section 206 issues an inquiry to external output mode management section 202 as to whether a directive to perform enlarged display of only part of a Web screen has been received, or a directive to perform enlarged display of an entire Web screen has been received. Furthermore, screen control section 206 outputs screen information, or data combining screen information and Web screen data (hereinafter referred to simply as “combined data” for convenience), from image buffer 212 to display section 213 or communication section 214 according to the directive.

Parameter changing section 207 detects whether or not parsed information input from information analysis section 204 by means of the screen control section 206 directive includes information in a format that cannot be processed by screen generation section 250. Parameter changing section 207 also detects whether or not there is a video object in the parsed information input from information analysis section 204. If the parsed information input from information analysis section 204 includes information in a format that cannot be processed by screen generation section 250 and a video object, parameter changing section 207 changes a parameter included in the video object to a parameter for performing total enlarged display of the video object on the display screen of external display apparatus 104. Then parameter changing section 207 outputs the video object including the changed parameter to plug-in calling section 208, and outputs an image buffer 212 write area to screen control section 206 and plug-in calling section 208. Also, parameter changing section 207 outputs the parsed information input from information analysis section 204 to Web screen generation and storage section 209, irrespective of whether or not the parsed information input from information analysis section 204 includes information in a format that cannot be processed by screen generation section 250, and irrespective of whether or not there is a video object in that parsed information.

Plug-in calling section 208 starts data processing section 211 by outputting the video object including a changed parameter and the image buffer 212 write area received from parameter changing section 207 to data processing section 211.

Web screen generation and storage section 209 generates Web screen data in accordance with Web screen display information that can be processed by screen generation section 250 among the Web screen display information input from parameter changing section 207, and holds that Web screen data.

Output screen generation section 210 extracts an area for display on display section 213 from the Web screen data held in Web screen generation and storage section 209, writes the extracted area to image buffer 212.

Data processing section 211 starts upon acquiring a video object including a changed parameter from plug-in calling section 208. After starting, data processing section 211 makes a request to data acquisition section 215 for acquisition of data from Web server 101 as necessary. Also, data processing section 211 performs decoding processing on the video object acquired from plug-in calling section 208. Furthermore, data processing section 211 performs decoding processing on data acquired by data acquisition section 215 as necessary, and generates screen information. Screen information generated at this time is screen information of a screen size specified by the changed parameter. Then data processing section 211 writes the generated screen information to the image buffer 212 write area acquired from plug-in calling section 208.

Image buffer 212 writes Web screen data input from output screen generation section 210 and screen information input from data processing section 211 to a predetermined area. Also, image buffer 212 outputs Web screen data, screen information, or combined data to display section 213 or communication section 214 in accordance with screen control section 206 control.

Display section 213 has a display surface with a smaller display area than the display surface of external display apparatus 104. Display section 213 displays an image of Web screen data, screen information, or combined data written to image buffer 212 in the above display area.

Communication section 214 outputs Web screen data, screen information, or combined data written to image buffer 212 to external display apparatus 104.

Data acquisition section 215 receives a request from data processing section 211, acquires data from Web server 101, and outputs the acquired data to data processing section 211. In FIG. 2, data acquisition section 215 is configured separately from information acquisition section 203, but may also be inside information acquisition section 203 in the implementation.

The data processing method used in communication system 100 will now be described using FIG. 1 and FIG. 2.

A user normally uses terminal apparatus 103. Information acquired by terminal apparatus 103 from Web server 101 is displayed on display section 213. As long as terminal apparatus 103 is connected to network 102 and can access Web server 101, the user can view a Web screen regardless of the user's location. When a situation arises in which external display apparatus 104 can be used due to movement of the user, terminal apparatus 103 becomes able to perform enlarged display of part or all of a Web screen specified by the user on external display apparatus 104. At this time, for example, the original Web screen is displayed on display section 213 of terminal apparatus 103, and a screen showing enlarged display of part of the Web screen displayed on display section 213 is displayed on external display apparatus 104. That is to say, different information is displayed on display section 213 of terminal apparatus 103 and on external display apparatus 104.

The operation of terminal apparatus 103 when terminal apparatus 103 accesses a video sharing service will now be described. Here, a video sharing service is a service that enables data uploaded to a server beforehand by a third party and stored in the server to be freely selected and viewed by means of streaming by a user who accesses the server.

When input section 201 of terminal apparatus 103 receives a directive from a user to acquire Web screen display information from Web server 101, input section 201 outputs input information directing acquisition of Web screen display information to information acquisition section 203.

When information directing acquisition of Web screen display information is input, information acquisition section 203 acquires Web screen display information from Web server 101.

Information analysis section 204 parses the Web screen display information input from information acquisition section 203, and generates parsed information.

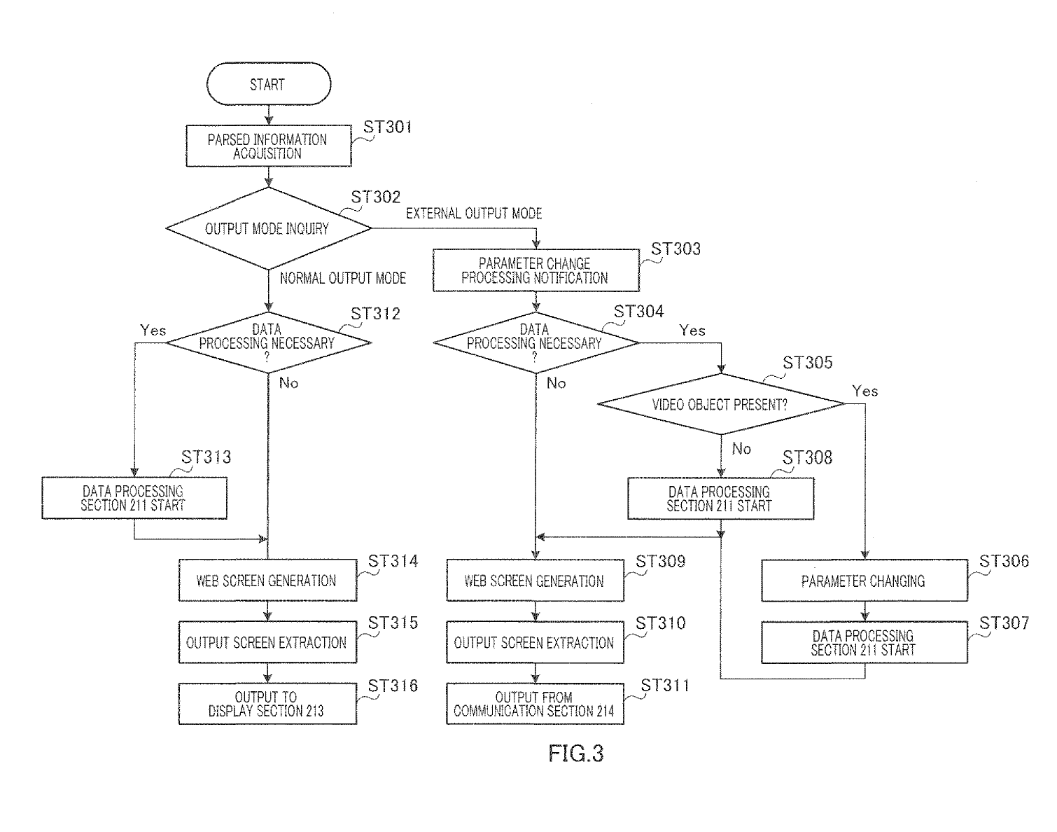

The operation of terminal apparatus 103 after this will now be described using FIG. 3. FIG. 3 is a flowchart showing the operation of terminal apparatus 103 when terminal apparatus 103 accesses a video sharing service.

When parameter changing section 207 acquires parsed information from information analysis section 204 (step ST301), screen control section 206 then issues an inquiry as to the output mode to external output mode management section 202 (step ST302).

If the result of the inquiry is that external output mode is set in external output mode management section 202 (step ST302: “External output mode”), screen control section 206 gives a directive for parameter change processing to parameter changing section 207 (step ST303). This directive is implemented by output of a parameter change processing notification by screen control section 206.

Next, parameter changing section 207 determines whether or not parsed information includes information in a format that cannot be processed by screen generation section 250—that is, whether or not data processing by data processing section 211 is necessary (step ST304).

If data processing is necessary (step ST304: Yes), parameter changing section 207 determines whether or not there is a video object in the parsed information (step ST305).

If a video object is included in the parsed information (step ST305: Yes), parameter changing section 207 changes a parameter included in the video object to a parameter enabling full-screen enlarged display of video on the display section of external display apparatus 104 (step ST306).

Next, parameter changing section 207 outputs a video object including a changed parameter, and an image buffer 212 write area, to plug-in calling section 208. In this case, the image buffer 212 write area is the entire display area of external display apparatus 104.

Plug-in calling section 208 notifies data processing section 211 of the video object including a changed parameter and the image buffer 212 write area acquired from parameter changing section 207, and starts data processing section 211 (step ST307). In this ease, a Web screen is not generated by screen generation section 250. Data processing section 211 performs decoding processing on the video object acquired from plug-in calling section 208, and generates screen information. When video data is not included in the video object acquired from plug-in calling section 208, data processing section 211 acquires video data from Web server 101 via data acquisition section 215.

Also, data processing section 211 writes the generated screen information to image buffer 212, and proceeds to the processing in step ST309.

On the other hand, if there is no video object in the parsed information in step ST305 (step ST305: No), parameter changing section 207 outputs an object other than a video object including a parameter, and an image buffer 212 write area, to plug-in calling section 208. Plug-in calling section 208 notifies data processing section 211 of the object including a parameter and the image buffer 212 write area, and starts data processing section 211 (step ST308). In this case, the image buffer 212 area is an area allocated for writing by data processing section 211. Data processing section 211 performs decoding processing on the object acquired from plug-in calling section 208 and generates screen information, writes the generated screen information to image buffer 212, and proceeds to the processing in step ST309.

If data processing is unnecessary in step ST304 (step ST304: No), the processing flow proceeds to step ST309.

Web screen generation and storage section 209 generates and holds a Web screen (step ST309).

Next, output screen generation section 210 extracts an area for display on display section 213 from the Web screen held in Web screen generation and storage section 209 (step ST310), and writes the extracted area to image buffer 212. The image buffer 212 write area at this time is an area excluding an area allocated for writing by data processing section 211.

If screen information generated by data processing section 211 has been written, image buffer 212 outputs the written screen information, or combined data combining the written screen information and a written Web screen, to communication section 214. Communication section 214 outputs the input screen information or combined data to external display apparatus 104 (step ST311). On the other hand, if screen information generated by data processing section 211 has not been written, image buffer 212 outputs a written Web screen to communication section 214. Communication section 214 outputs the input Web screen to external display apparatus 104 (step ST311).

By means of the above-described operation of screen generation section 250, when accessing a video sharing service, terminal apparatus 103 can extract only a specific object such as a video object, enlarge this object, and display it on external display apparatus 104.

On the other hand, if normal output mode is set in external output mode management section 202 (step ST302; “Normal output mode”), parameter changing section 207 determines whether or not the parsed information includes information in a format that cannot be processed by screen generation section 250. That is to say, parameter changing section 207 determines whether or not data processing by data processing section 211 is necessary (step ST312).

If data processing is necessary (step ST312: Yes), parameter changing section 207 outputs an object including a parameter, without changing the parameter, and an image buffer 212 write area, to plug-in calling section 208, Plug-in calling section 208 notifies data processing section 211 of the object including a parameter and the image buffer 212 write area, and starts data processing section 211 (step ST313). Data processing section 211 performs decoding processing on the object acquired from plug-in calling section 208, and generates screen information. Then data processing section 211 writes the generated screen information to image buffer 212, and proceeds to the processing in step ST314. Also, if the object acquired from plug-in calling section 208 is a video object and that video object does not include video data, data processing section 211 acquires video data from Web server 101 via data acquisition section 215.

On the other hand, if data processing is not necessary in step ST312 (step ST312: No), terminal apparatus 103 proceeds to the processing in step ST314.

Next, Web screen generation and storage section 209 generates a Web screen using information that can be processed by screen generation section 250 among the parsed information, and holds that Web screen (step ST314).

Then output screen generation section 210 extracts an area for display on display section 213 from the Web screen held in Web screen generation and storage section 209, and writes the extracted area to image buffer 212 (step ST315). The image buffer 212 write area at this time is an area excluding an area allocated for writing by data processing section 211.

Next, if screen information generated by data processing section 211 has been written, image buffer 212 outputs combined data to display section 213 (step ST316), if screen information generated by data processing section 211 has not been written, image buffer 212 outputs the written Web screen to display section 213 (step ST316).

This concludes a description of FIG. 3.

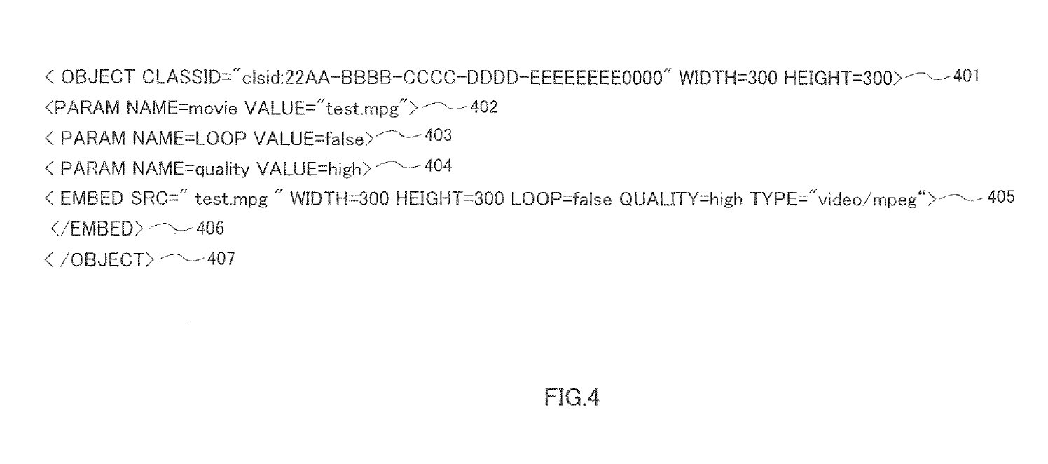

FIG. 4 is a drawing showing an extract of data of a Web page including video, and conforms to HTML or XHTML standardized by W3C. That is to say, FIG. 4 shows a part of Web screen display information.

In FIG. 4, tag 401 is an OBJECT tag. An OBJECT tag specifies a class ID of content by means of a CLASSID attribute. A class ID is an ID that uniquely identifies an application. The WIDTH attribute and HEIGHT attribute written in tag 401 specify the horizontal length and vertical length respectively of a display area. Tag 402 specifies the address of a video file to be output. Tag 403 and tag 404 contain playback method parameters.

Tag 405 is an EMBED tag. An EMBED tag is a tag for specifying pasting of an object in a Web page, and prescribes an object display method. The EMBED tag specifies the name of a video file to be output by means of an SRC attribute, and specifies the horizontal and vertical lengths of a display area by means of a WIDTH attribute and HEIGHT attribute. In addition, the EMBED tag specifies a playback method by means of a LOOP attribute and QUALITY attribute, and specifies a MIME type by means of a TYPE attribute. A MIME type prescribes the type, encoding format, and so forth of content. FIG. 4 shows a case in which an image included in a Web page is of MPEG type, but other video formats may also be used.

Tag 406 is a tag indicating the end of an EMBED description, and tag 407 is a tag indicating the end of an OBJECT description. As shown in FIG. 4, an object is configured by means of tag 401 and tag 407. FIG. 4 shows only one object, but in actuality, Web screen display information is composed of a plurality of objects.

Parameter changing section 207 stores an above-described class ID and MIME type beforehand. Parameter changing section 207 determines from a CLASSID attribute in a tag 401 OBJECT tag whether or not Web screen display information includes information in a format that cannot be processed by screen generation section 250. Furthermore, parameter changing section 207 compares a previously stored video class ID and MIME type with a class ID and MIME type of acquired Web screen display information. Then, if there is a matching class ID or MIME type, parameter changing section 207 determines that video is included in the acquired Web page. In the case of a MIME type, a video type such as video/mpeg or part of an application type corresponds to video.

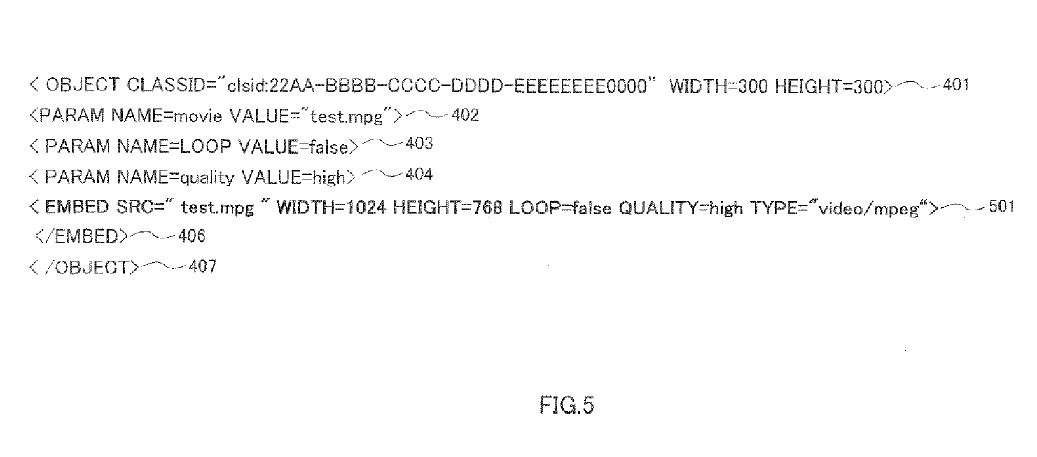

FIG. 5 is a drawing showing data after parameter changing section 207 has performed parameter changing on the data shown in FIG. 4 in order to perform full-screen display of a Web page corresponding to the data shown in FIG. 4 on the display section of external display apparatus 104.

As shown in FIG. 5, parameter changing section 207 changes tag 405, the EMBED tag, to tag 501. Tag 501 specifies the horizontal length and vertical length respectively of a display area of external display apparatus 104 by means of the WIDTH attribute and HEIGHT attribute of the EMBED tag. When communication between terminal apparatus 103 and external display apparatus 104 becomes possible, screen generation section 250 performs communication with external display apparatus 104 via communication section 214 and acquires information relating to the display area of external display apparatus 104, and holds this information internally beforehand.

The description method of a parameter passed to data processing section 211 by parameter changing section 207 differs according to the browser implementation. Plug-in calling section 208 according to this embodiment starts data processing section 211 based on the contents of an EMBED tag. Therefore, parameter changing section 207 need only change the WIDTH attribute and HEIGHT attribute of the EMBED tag.

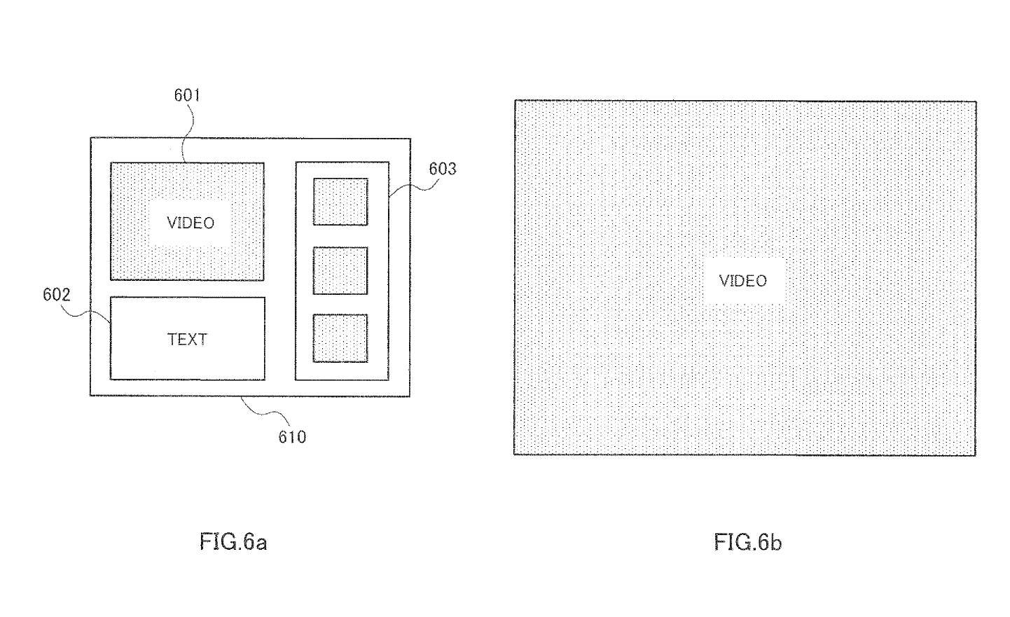

FIG. 6 (a) is a drawing showing Web screen 610 displayed on display section 213, and shows Web screen 610 provided when a typical video sharing service is accessed. FIG. 6 (b) is a drawing showing a screen displayed on external display apparatus 104.

In FIG. 6 (a), area 601 is a screen that is part of Web screen 610, and is a screen area for displaying video. Also, area 601 is an area for performing video playback by means of data processing such as decoding processing by data processing section 211. Area 602 is a text area, in which a description of video played back in area 601, a comment by another user who has viewed the video played back in area 601, or the like, is written. Area 603 is an area for displaying a list of other recommended videos related to the video played back in area 603. Having a recommended video list displayed in area 603 enables a user to easily select a desired video from among countless existing videos.

Also, as shown in FIG. 6 (b), external display apparatus 104 performs enlarged display of video displayed in area 601 displayed on display section 213 of terminal apparatus 103. Video displayed in area 601 is part of a Web screen displayed on terminal apparatus 103 as shown in FIG. 6 (a).

A user can view video played back in large-screen format by playing back area 601 video in enlarged display on external display apparatus 104. Then, while watching video played back on a large screen, the user can simultaneously read a description of the video played back on external display apparatus 104, or a comment of another user who has viewed that video, displayed in area 602 of terminal apparatus 103. Also, while watching video played back on the large screen of external display apparatus 104, the user can select the next video to be played back from area 603 of terminal apparatus 103. Video content link information is embedded in the recommended video list in area 603. When the user clicks and selects the name or icon of video to be viewed next from the list, terminal apparatus 103 rewrites area 601, and plays back the selected video content in area 601.

In order to play back an area 603 recommended video list on external display apparatus 104, a mechanism for enabling terminal apparatus 103 to recognize that the mode is external output mode when list selection is performed is necessary. As described later herein, changing the selection method for the link destination of link information in a Web screen between normal mode and external output mode enables terminal apparatus 103 to differentiate between the normal mode and the external output mode.

The screen modes and methods of use illustrated in FIG. 6 (a) and FIG. 6 (b) are only examples, and other screen modes and methods of use can also be envisaged, such as enabling a user reading a blog entry to perform enlarged display of a photograph of interest on external display apparatus 104.

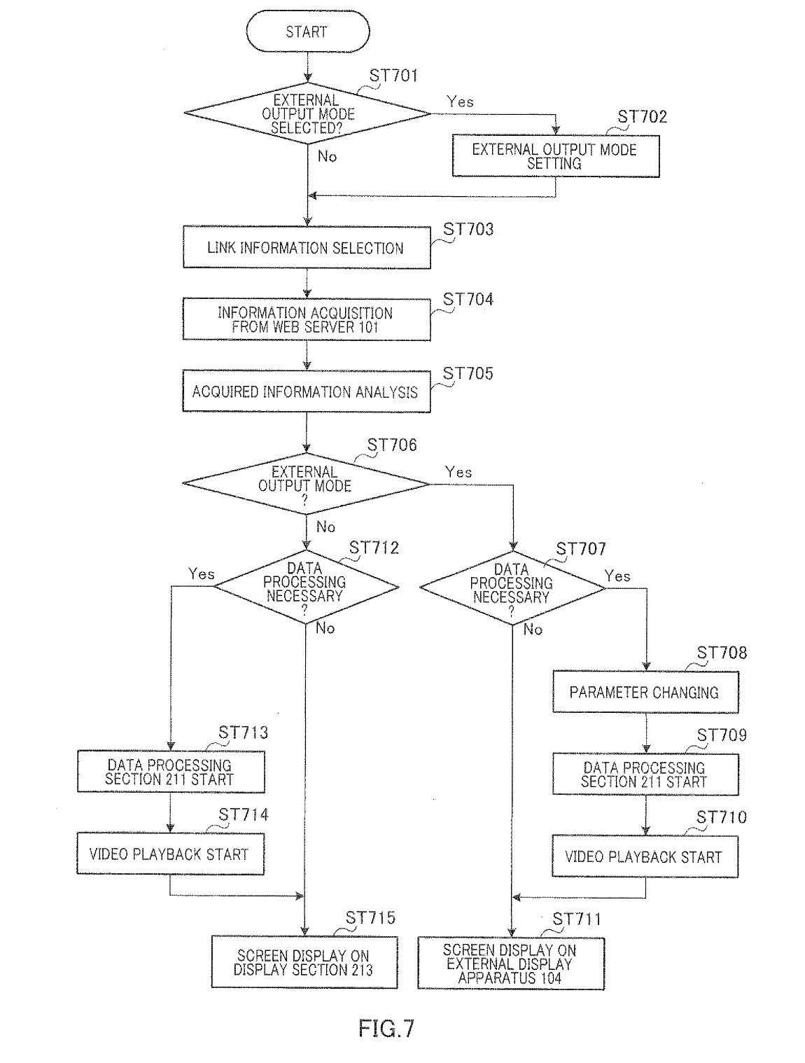

The operation of terminal apparatus 103 when a link destination screen of link information in a Web screen is displayed will now be described using the flowchart in FIG. 7. FIG. 7 is a flowchart showing terminal apparatus 103 operation when a link destination screen of link information in a Web screen is displayed.

In the initial state, terminal apparatus 103 is displaying a Web screen on display section 213 (Start).

First, as a result of link information in the Web screen being displayed on display section 213 being selected, terminal apparatus 103 acquires new Web screen display information from Web server 101, and rewrites the display section 213 screen display with the next Web screen. When selecting link information, the user can select display of the new Web screen display information corresponding to the selected link information by rewriting display section 213 of terminal apparatus 103, or enlarged display of that new Web screen display information on external display apparatus 104.

Input section 201 of terminal apparatus 103 receives a directive from the user, and notifies external output mode management section 202 of input information indicating the directive contents.

On receiving input information, external output mode management section 202 determines, based on that input information, whether or not external output mode, which is the mode for output to external display apparatus 104, has been selected (step ST701).

If external output mode has been selected (step ST701: Yes), external output mode management section 202 sets external output mode (step ST702).

On the other hand, if external output mode has not been selected in step ST701 (step ST701: No), terminal apparatus 103 proceeds to the processing in step ST703.

Next, when input section 201 receives input from outside selecting link information (step ST703), input section 201 outputs the input information to information acquisition section 203. Link information selection is performed in the initial-state Web screen displayed on display section 213. Information acquisition section 203 of terminal apparatus 103 acquires an input information URL from among HTML or suchlike Web screen display information stored (cached) in storage section 205. Then information acquisition section 203 acquires new Web screen display information from Web server 101 based on the acquired URL (step ST704).

Next, information acquisition section 203 outputs the acquired Web screen display information to information analysis section 204. Information analysis section 204 analyzes and parses the received Web screen display information, and outputs the result to parameter changing section 207 (step ST705). At this time, information analysis section 204 issues an inquiry to external output mode management section 202. If the result of the inquiry is that the mode is external output mode, information analysis section 204 then secures a new storage area different from the initial-state Web screen storage area in storage section 205, and writes parsed information to the secured new storage area in storage section 205. Screen control section 206 issues an inquiry to external output mode management section 202, and determines whether or not external output mode has been set (step ST706).

If external output mode has been set (step ST706: Yes), Web screen generation and storage section 209 generates a Web screen to be displayed on external display apparatus 104 based on the parsed information generated by information analysis section 204, and writes this Web screen to image buffer 212. At this time, the area of image buffer 212 to which the Web screen is written is an area different from the area of image buffer 212 for the Web screen displayed on display section 213 in the initial state. Therefore, the Web screen being displayed on display section 213 of terminal apparatus 103 is not affected by writing of a Web screen for external display apparatus 104 use. Parameter changing section 207 determines whether or not parsed information includes information in a format that cannot be processed by screen generation section 250. That is to say, parameter changing section 207 determines whether or not data processing by data processing section 211 is necessary (step ST707).

If data processing by data processing section 211 is necessary (step ST707: Yes), parameter changing section 207 performs parameter changing in accordance with the external display apparatus 104 display screen (step ST708).

Next, plug-in calling section 208 starts data processing section 211 (step ST709), and notifies data processing section 211 of the image buffer 212 write area and various parameters for which data processing is necessary, including changed parameters.

Also, as necessary, data processing section 211 acquires video data from Web server 101 via data acquisition section 215, performs decoding processing on the acquired video data, and starts video playback (step ST710). Furthermore, data processing section 211 writes screen information to the specified area of image buffer 212.

In addition, image buffer 212 outputs screen information or combined data written from data processing section 211 to communication section 214. Here, combined data is data combining Web screen data written from output screen generation section 210 and screen information written from data processing section 211. Then communication section 214 performs screen display on external display apparatus 104 by outputting screen information or combined data to external display apparatus 104 (step ST711).

If data processing by data processing section 211 is not necessary (step ST707: No), output screen generation section 210 extracts a Web screen generated by Web screen generation and storage section 209, and writes the extracted screen to a specified area of image buffer 212. Image buffer 212 outputs the written Web screen to communication section 214. Communication section 214 outputs the input Web screen to external display apparatus 104. By this means, external display apparatus 104 performs screen display (step ST711).

On the other hand, if the mode is not external output mode (step ST706: No), parameter changing section 207 determines whether or not the parsed information includes information in a format that cannot be processed by screen generation section 250. That is to say, parameter changing section 207 determines whether or not data processing by data processing section 211 is necessary (step ST712).

If data processing by data processing section 211 is necessary (step ST712: Yes), plug-in calling section 208 starts data processing section 211 (step ST713), and notifies data processing section 211 of the image buffer 212 write area and various parameters necessary for data processing, without performing parameter changing.

Also, as necessary, data processing section 211 acquires video data from Web server 101 via data acquisition section 215, performs decoding processing on the acquired video data and generates screen information, and starts video playback (step ST714). Furthermore, data processing section 211 writes the generated screen information to the specified area of image buffer 212.

In addition, image buffer 212 performs screen display on display section 213 by outputting combined data written from data processing section 211 to display section 213 (step ST715). Here, combined data is data combining a Web screen written from input section 201 and screen information written from data processing section 211.

If data processing by data processing section 211 is not necessary in step ST712 (step ST712: No), output screen generation section 210 extracts a Web screen generated by Web screen generation and storage section 209, and writes the extracted screen to a specified area of image buffer 212. Then image buffer 212 performs screen display on display section 213 by outputting the written Web screen to display section 213 (step ST715).

By means of the above-described operation, terminal apparatus 103 can accept selection of link information in a Web screen displayed on display section 213, and acquire new Web screen display information from Web server 101. Then, when rewriting the screen display with the next Web screen, terminal apparatus 103 can accept selection from the user of display by rewriting display section 213 of terminal apparatus 103, or enlarged display on external display apparatus 104. Then, when a new Web screen is displayed in enlarged form on external display apparatus 104, terminal apparatus 103 can maintain the display state of the Web screen displayed on display section 213 without being affected at all.

When selection of a Web screen to be displayed on external display apparatus 104 is accepted in the Web screen, and the link destination is a Web screen provided by a typical video sharing service as shown in FIG. 6 (a), it is desirable for a screen displayed on external display apparatus 104 to be that in FIG. 6 (b) rather than that in FIG. 6 (a).

This concludes a description of the operation of terminal apparatus 103 when a link destination screen of link information in a Web screen is displayed (a description of FIG. 7).

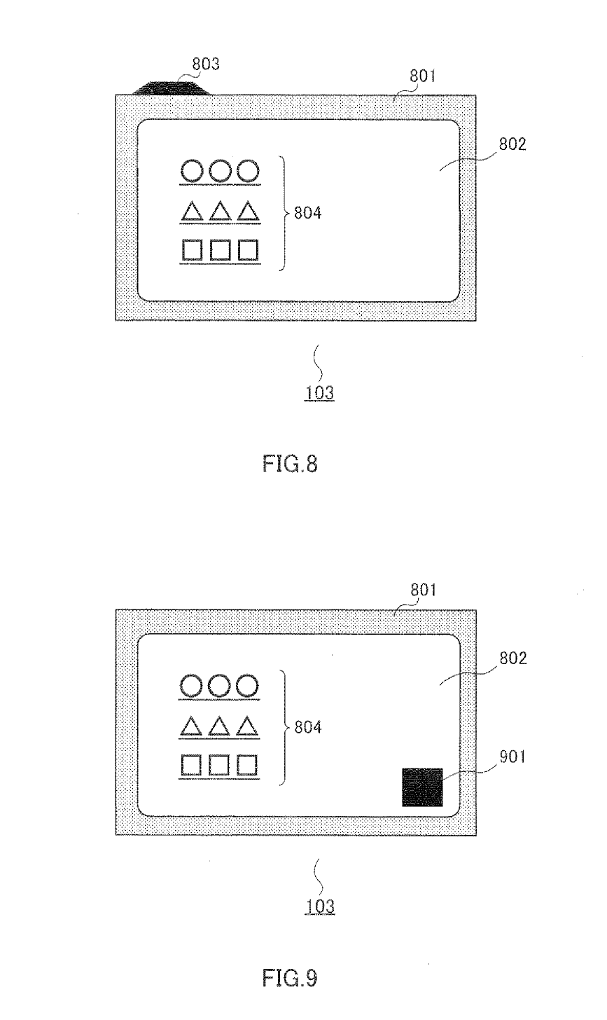

Examples of the configuration of input section 201 of terminal apparatus 103 will now be described using FIG. 8 and FIG. 9. FIG. 8 and FIG. 9 are drawings showing examples of the configuration of terminal apparatus 103.

Terminal apparatus 103 is composed of case 801, display section 802 exposed on the surface of case 801, and input section 803 provided on case 801 and protruding from case 801. Here, display section 802 corresponds to display section 213 in FIG. 2, and input section 803 corresponds to input section 201 in FIG. 2.

Input section 803 functions as a display output mode selection button. That is to say, a user can perform switching of Web screen output via input section 803. When it is wished to perform normal Web screen manipulation first, the conventional method of use can be set without the user having to perform special manipulation. On the other hand, when it is wished to perform Web screen output from terminal apparatus 103 to external display apparatus 104 (that is, Web screen display on external display apparatus 104), the user manipulates input section 803. This manipulation may be, for example, to click and select one item of Web screen link information 804 displayed on display section 802 using the right hand while pressing input section 803 with the forefinger of the left hand. On receiving this manipulation, terminal apparatus 103 performs the processing described in FIG. 7, and switches Web screen output from display section 213 to external display apparatus 104.

Also, manipulations for switching Web screen output may be, for example, to switch Web screen Output from display section 213 to external display apparatus 104 by pressing input section 803 using the forefinger of the left hand, and then to perform link information selection by clicking one item of Web screen link information 804 displayed on display section 802 using the right hand. On receiving these manipulations, terminal apparatus 103 performs the processing described in FIG. 7, and switches Web screen output from display section 213 to external display apparatus 104. The placement of input section 803 relative to case 801 in FIG. 8 is only an example, and the placement of input section 803 is not limited to this.

Also, the above-described manipulations are only examples, and in implementation of the present invention manipulations are not limited to these examples, as long as it is possible to differentiate between a normal manipulation and an external display apparatus output manipulation. Other concrete examples of manipulations for differentiation of Web screen display output that can be imagined are shown below.

A first example is a terminal apparatus 103 for which user manipulation differs slightly from that described above. That is to say, an input section comprising a display output mode selection button provides for switching between normal output mode and external display apparatus output mode in a toggling fashion. In this ease, terminal apparatus 103 performs Web screen output to external display apparatus 104 according to the output mode set in the input section when link information is selected. The user is notified of the currently set output mode by means of a display, LED, or the like. Such a terminal apparatus 103 enables the trouble of pressing an input section button to be eliminated, and is particularly advantageous to the user when output to external display apparatus 104 is successively used to a great extent.

A second example is a terminal apparatus 103 in which an input section functioning as a display output mode selection button is implemented by software. In this case, input section 901 is provided at the edge of display section 802. Input section 901 manipulations are carried out in the same kind of way as described with reference to FIG. 8. Such a terminal apparatus 103 need not be provided with an input section as hardware, offering advantages in terms of cost and design, for example. Furthermore, a terminal apparatus 103 in which input section 901 is semi-transparent can be imagined as another aspect of this example. Such a terminal apparatus 103 enables occupation of the screen area of display section 802 to be avoided.

A third example is a terminal apparatus 103 in which an input section is a touch panel, and an input section that accepts link information selection and functions as an external display apparatus 104 output mode selection button is displayed on the screen. In this case, terminal apparatus 103 performs Web screen output to external display apparatus 104 when the displayed input section is pressed.

As a basic operation when the input section is a touch panel, terminal apparatus 103 first acquires a touched event via the input section, but at this point in time, link information is not considered to have been selected. When the touching finger is removed from the touch panel, the input section acquires the event from which the finger has been removed following the touched event. Only then does terminal apparatus 103 consider link information to have been selected, and perform corresponding processing.

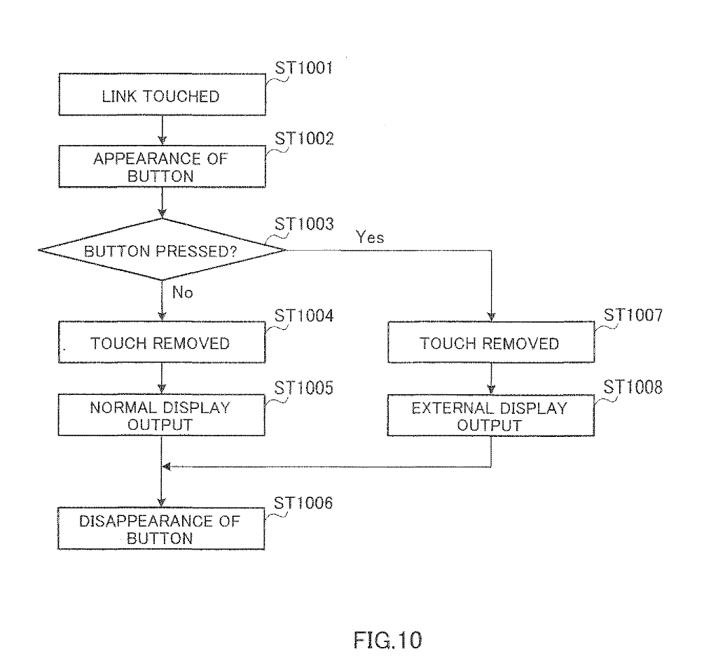

The operation of terminal apparatus 103 in the case of the above third example will now be described using FIG. 10. FIG. 10 is a flowchart showing terminal apparatus 103 operation when an input section is manipulated. In the following description, FIG. 9 will be used as a screen image.

First, when one of the items of link information in a Web screen displayed on display section 802 is touched by the user (step ST1001), terminal apparatus 103 displays input section 901 functioning as a display output mode selection button on display section 802 (step ST1002).

The placement of input section 901 in FIG. 9 is only an example, and the placement of input section 901 is not necessarily limited to this. For example, terminal apparatus 103 may display input section 901 in the vicinity of link information touched by the user.

If a finger is removed from display section 802 (step ST1004) without displayed input section 901 having been pressed (step ST1003: No), terminal apparatus 103 displays a link destination Web screen on display section 802 (step ST1005). At this time, input section 901 disappears from display section 802 (step ST1006).

On the other hand, if input section 901 is pressed (step ST 1003: Yes) and a finger is removed from display section 802 (step ST1007), a link destination Web screen is displayed on external display apparatus 104 (step ST1008). In this case, also, input section 901 then disappears from display section 802 (step ST1006).

A fourth example is a terminal apparatus 103 in which an input section is a touch panel, and an input section that is an external display apparatus 104 output icon is displayed on display section 802 through link information being selected. When a drag-and-drop manipulation is performed on link information touched in the displayed input section, terminal apparatus 103 performs link destination Web screen output to external display apparatus 104. Here, drag-and-drop is a manipulation whereby a touching finger is slid to a target object (in this case, an input section that is an output icon) without being removed from display section 802, and is removed from display section 802 when over the target object. An advantage of such a terminal apparatus 103 as compared with the third example is that the entire operation from selection of link information to manipulation for output to external display apparatus 104 can be completed using the single finger that selects link information. If a finger is removed from display section 802 without execution of a drag-and-drop, terminal apparatus 103 outputs a link destination Web screen to display section 802.

Thus, according to this embodiment, enlarged display of a Web screen can be performed on external display apparatus 104 on an object-by-object basis, and user convenience can be greatly improved. Also, according to this embodiment, by displaying an object composing a Web screen on external display apparatus 104, part of a Web screen can be displayed on external display apparatus 104, and ease of use of a Web screen can be greatly improved. Furthermore, according to this embodiment, a user interface can be provided that enables easy differentiated use of Web screen display modes when a user manipulating a Web screen using terminal apparatus 103 wants normal Web screen manipulation, and when such a user wants Web screen display on external display apparatus 104. Moreover, according to this embodiment, video of a video sharing site and video referenced in a blog can be played back in full-screen display on external display apparatus 104. By this means, in an environment in which normal Web screen manipulation on terminal apparatus 103 continues to be basic, and external display apparatus 104 is located in the vicinity, a still image, video, or link destination information in a Web screen displayed on terminal apparatus 103 can be output to external display apparatus 104 by means of simple manipulation. In addition, according to this embodiment, by providing for only a video object to be extracted from parsed information and displayed on external display apparatus 104, it is possible for only a video object to be enlarged and displayed separately from terminal apparatus 103. At this time, a Web screen that is not displayed on display section 213 of terminal apparatus 103 is maintained without being affected at all, and therefore a user can watch high-resolution video on a large screen while reading Web screen text information or the like.

In this embodiment, a target of parameter changing has been assumed to be a parameter assigned to a video object, but the present invention is not limited to this, and a parameter assigned to any object, not only a video object, can be changed.

Another aspect of this embodiment will now be described.

In the above embodiment, a case has been described in which a general-purpose browser operates in terminal apparatus 103. However, it is also possible for the present invention to be applied to a terminal apparatus in which a network application whose object is to access only a specific Web server or a specific Web service operates.

Here, a network application is application software that is equivalent to a subset of a general-purpose browser, and for which accessing a predetermined specific website is a presupposition. Such application software is generally called a widget or gadget.

With a normal general-purpose browser, after starting the browser a user has to input the URL of a website to be accessed, or select a link. On the other hand, with a network application, a state in which a specific website has been accessed is established immediately after the application is started, thus offering the advantage of saving the user trouble. In addition, a network application is provided with an optimal user interface for using a specific website, offering the advantage of ease of manipulation.

A YouTube (registered trademark) player is known as a network application for using a video sharing service. A YouTube (registered trademark) player is a special-purpose application for accessing the website of YouTube (registered trademark), a video sharing service, and selecting and viewing video content.

According to another aspect of this embodiment, full-screen playback display of a screen displayed on display section 213 of terminal apparatus 103 can be performed on external display apparatus 104 through the operation of a network application such as described above.

The configuration of terminal apparatus 103 according to another aspect of this embodiment is almost identical to the configuration shown in FIG. 2. Since an above-described network application is a subset of a browser, part of the configuration of terminal apparatus 103 is unnecessary, and some of the configuration functions are limited. Specifically, information acquisition section 203 need only acquire Web screen display information from a specific Web server. Also, since the website to be connected to is known beforehand, information analysis section 204 need only be able to analyze Web screen display information for the website to be connected to. Similarly, data processing section 211 need only be able to process a data format used by the website to be connected to, and may be integrated with plug-in calling section 208 and placed inside screen generation section 250.

The operation of terminal apparatus 103 according to another aspect of this embodiment is identical to that shown in FIG. 3.

Thus, according to another aspect of this embodiment, it is possible to perform enlarged display of a network application screen on external display apparatus 104, and user convenience can be greatly improved. Also, a user interface can be provided that enables easy differentiated use of Web screen display modes when a user manipulating a network application screen using terminal apparatus 103 wants normal application screen manipulation, and when such a user wants application screen display on external display apparatus 104.

A terminal apparatus according to one aspect of the present invention employs a configuration having: an acquisition section that acquires Web screen display information composed of an object including a parameter indicating a screen size of a Web screen; a changing section that changes the parameter so that the screen size is increased; a data processing section that generates screen information of the screen size specified by the changed parameter by performing decoding processing on the object; and an output section that outputs the generated screen information externally.

A terminal apparatus according to another aspect of the present invention employs a configuration having: an acquisition section that acquires an object including a parameter specifying a screen size of a network application screen; a changing section that changes the parameter so that the screen size is increased; a data processing section that generates screen information of the screen size specified by the changed parameter by performing decoding processing on the object; and an output section that outputs the generated screen information externally.

A data processing method according to another aspect of the present invention has: a step of acquiring Web screen display information composed of an object including a parameter specifying a screen size of a Web screen; a step of changing the parameter so that the screen size is increased; and a step of generating screen information of the screen size specified by the changed parameter by performing decoding processing on the object.

A data processing method according to another aspect of the present invention has: a step of acquiring an object including a parameter specifying a screen size of a network application screen; a step of changing the parameter so that the screen size is increased; and a step of generating screen information of the screen size specified by the changed parameter by performing decoding processing on the object.

The disclosure of Japanese Patent Application No. 2008-171227, filed on Jun. 30, 2008, including the specification, drawings and abstract, is incorporated herein by reference in its entirety.

### INDUSTRIAL APPLICABILITY

A terminal apparatus and data processing method according to the present invention are particularly suitable for connecting to an external display apparatus and displaying a screen on the external display apparatus.

### REFERENCE SIGNS LIST

100 Communication system
101 Web server
102 Network
103 Terminal apparatus
104 External display apparatus
201 Input section
202 External output mode management section
203 Information acquisition section
204 Information analysis section
205 Storage section
206 Screen control section
207 Parameter changing section
208 Plug-in calling section
209 Web screen generation and storage section
210 Output screen generation section
211 Data processing section
212 Image buffer
213 Display section
214 Communication section
215 Data acquisition section
250 Screen generation section

1-20. (canceled)

21. A terminal apparatus that is a portable terminal capable of connection to an external display apparatus, the terminal apparatus comprising:
an acquisition section that acquires Web screen display information composed of a plurality of objects;
an information analysis section that extracts a video object including a parameter specifying a size of a display area from the Web screen display information;
a changing section that changes the parameter so that a size of a display area of the video object is increased;
a data processing section that generates screen information of a size of a display area specified by the changed parameter by performing decoding processing on the video object; and
an output section that outputs the screen information to the external display apparatus.

22. The terminal apparatus according to claim 21, further comprising:
an input section that sets a mode in which the screen information is output or is not output to the external display apparatus; and
a screen control section that controls the output section and the changing section based on the mode set by the input section,
wherein, when the mode has been set to a mode in which the screen information is output to the external display apparatus, the screen control section issues a directive to the changing section for a change of the parameter so that the size of a display area is increased, and issues a directive to the output section for output of the screen information to the external display apparatus.

23. The terminal apparatus according to claim 21, further comprising a display section that displays the Web screen,
wherein the acquisition section, when the Web screen displayed on the display section includes link information, acquires Web screen display information of a link destination of the link information.

24. The terminal apparatus according to claim 23, further comprising:
an input section that sets a mode in which the screen information is output or is not output to the external display apparatus; and
a screen control section that controls the output section and the changing section based on a mode set by the input section, wherein:
the input section notifies the acquisition section of the selected link information; and when the mode has been set to a mode in which the screen information is output to the external display apparatus, the screen control section issues a directive to the changing section for a change of the parameter so that the size of a display area is increased, and issues a directive to the output section for output of the screen information to the external display apparatus.

25. The terminal apparatus according to claim 24, wherein the display section displays a Web screen that presents the link information as an option of the input section.

26. The terminal apparatus according to claim 22, wherein the input section includes an output mode selection button, and during manipulation of the output mode selection button, sets the mode to a mode in which the screen information is output to the external display apparatus.

27. The terminal apparatus according to claim 24, wherein the input section includes an output mode selection button, and during manipulation of the output mode selection button, sets the mode to a mode in which the screen information is output to the external display apparatus.

28. The terminal apparatus according to claim 24, wherein the input section includes an output mode selection button, and in the process of selection of the link information by the input section, displays the output mode selection button in a screen of the display section.

29. The terminal apparatus according to claim 21, wherein:
the Web screen display information is HTML or XHTML; and
the video object is configured by means of an OBJECT tag or EMBED tag.

30. The terminal apparatus according to claim 24, wherein the acquisition section, when the output section outputs the screen information to the external display apparatus, acquires a video object that becomes a basis of the screen information from a Web server.

31. The terminal apparatus according to claim 24, further comprising a display section that displays the Web screen,
wherein the input section displays an icon in the Web screen, and when manipulation is performed on the icon, sets a mode in which the screen information is output to the external display apparatus.

32. A terminal apparatus that is a portable terminal capable of connection to an external display apparatus, the terminal apparatus comprising:
an acquisition section that acquires a video object including a parameter specifying a size of a display area and another object, composing a network application screen;
a changing section that changes the parameter so that a size of a display area of the video object is increased;
a data processing section that generates screen information of a size of a display area specified by the changed parameter by performing decoding processing on the video object; and
an output section that outputs the generated screen information to the external display apparatus.

33. The terminal apparatus according to claim 32, further comprising:
an input section that sets a mode in which the screen information is output or is not output to the external display apparatus; and
a screen control section that controls the output section and the changing section based on the mode set by the input section,
wherein, when the mode has been set to a mode in which the screen information is output to the external display apparatus, the screen control section issues a directive to the changing section for a change of the parameter so that the size of a display area is increased, and issues a directive to the output section for output of the screen information to the external display apparatus.

34. A data processing method that is used by a terminal apparatus capable of connection to an external display apparatus, the data processing method comprising:
a step of acquiring Web screen display information composed of a plurality of objects;
a step of extracting a video object including a parameter specifying a size of a display area from the Web screen display information;
a step of determining whether or not screen information is to be output to the external display apparatus;
a step of changing the parameter so that a size of a display area of the video object is increased when it is determined that the screen information is to be output to the external display apparatus;
a step of generating screen information of the size of a display area specified by a changed parameter by decoding the video object; and
a step of outputting the screen information to the external display apparatus.

35. The data processing method according to claim 34, further comprising:
a step of, when a Web screen displayed by the display section includes link information, detecting whether or not the link information has been touched;
a step of, when the link information is detected to have been touched, next detecting whether or not the touch has been removed;
a step of, when the touch is detected to have been removed, selecting the link information; and
a step of acquiring Web screen display information of a link destination of the selected link information.

36. The data processing method according to claim 34, further comprising:
a step of detecting whether or not an output mode selection button that sets whether or not the screen information is to be output to the external display apparatus has been pressed; and
a step of, when the output mode selection button is detected to have been pressed, determining that the screen information is to be output to the external display apparatus.

37. The data processing method according to claim 35, further comprising:
a step of detecting whether or not an output mode selection button that sets whether or not the screen information is to be output to the external display apparatus has been pressed; and
a step of, when the output mode selection button is detected to have been pressed, determining that the screen information is to be output to the external display apparatus.

38. The data processing method according to claim 35, further comprising:
a step of displaying an output mode selection button on the display section immediately after the link information is detected to have been touched in a step of detecting whether or not the link information has been touched;
a step of detecting whether or not the output mode selection button has been pressed when the touch has been detected to have been removed in a step of detecting whether or not the touch has been removed; and
a step of, when the output mode selection button is detected to have been pressed, determining that the screen information is to be output to the external display apparatus.

39. The data processing method according to claim 35, further comprising:
a step of displaying an output mode selection button on the display section immediately after the link information is detected to have been touched in a step of detecting whether or not the link information has been touched;
a step of detecting whether or not the link information has been dragged;
a step of, when the link information has been detected to have been dragged, next detecting whether or not the dragged link information has been dropped in a predetermined area of the output mode selection button; and
a step of, when the link information is detected to have been dropped in a predetermined area of the output mode selection button, determining that the screen information is to be output to the external display apparatus.

40. A data processing method that is used by a terminal apparatus capable of connection to an external display apparatus, the data processing method comprising:
a step of acquiring a video object including a parameter specifying a size of a display area and another object, composing a network application screen;
a step of determining whether or not screen information is to be output to the external display apparatus;
a step of changing the parameter so that a size of a display area of the video object is increased when it is determined that the screen information is to be output to the external display apparatus;
a step of generating screen information of the size of a display area specified by the changed parameter by decoding the video object; and
a step of outputting the screen information to the external display apparatus.
